(19) United States
(12) Patent Application Publication
(10) Pub. No.: US 2020/0404672 A1
(43) Pub. Date: Dec. 24, 2020

(54) METHOD AND APPARATUS FOR INFORMATION DETERMINATION AND CONFIGURATION, AND COMPUTER STORAGE MEDIUM

(71) Applicant: Guangdong Oppo Mobile Telecommunications Corp., Ltd., Dongguan (CN)

(72) Inventors: Zhihua Shi, Dongguan (CN); Wenhong Chen, Dongguan (CN); Zhi Zhang, Dongguan (CN)

(21) Appl. No.: 17/009,752

(22) Filed: Sep. 1, 2020

Related U.S. Application Data
(63) Continuation of application No. PCT/CN2018/081845, filed on Apr. 4, 2018.

(51) Int. Cl. H04W 72/04; H04B 7/06; H04L 5/00

(52) U.S. Cl. CPC H04W 72/0493; H04L 5/0023; H04L 5/0051; H04B 7/0626

(57) ABSTRACT

Disclosed are a method and device for information determination and configuration, and a computer storage medium. The method comprises: a terminal device receiving first configuration information transmitted by a network device, the first configuration information being used for configuring a set of CSI-RS resources, where CSI-RS resources in the set of CSI-RS resources are quasi co-located with respect to a first QCL parameter.

### CROSS-REFERENCE TO RELATED APPLICATIONS

The application is a continuation application of PCT Application No. PCT/CN2018/081845 filed on Apr. 4, 2018, the disclosure of which is hereby incorporated by reference in its entity.

### BACKGROUND

In a Long Term Evolution (LTE) system, Cell-specific Reference Signals (CRSs) exist within a system bandwidth. Thus, the CRSs are with a relatively large bandwidth and a relatively large time domain density, such that a terminal can use a CRS (and/or a synchronization signal) to obtain a better time/frequency synchronization performance (e.g. timing/frequency tracking, or timing/frequency synchronization).

In a New Radio (NR) system, a Synchronization Signal Block (SSB) (which includes a Primary Synchronization Signal (PSS), a Secondary Synchronization Signal (SSS) and a Physical Broadcast Channel (PBCH)) only occupies a part of the bandwidth, and its time domain density is lower than the time domain density of the CRS in the LTE system, therefore the SSB can be used for coarse synchronization. However, in cases where time-frequency synchronization with higher precision is required, the synchronization requirement can be met. Furthermore, there are no CRSs in the NR system, a new signal synchronization reference signal (Tracking Reference Signal (TRS)) is thus proposed. In the final design, the TRS is implemented in the following manner (where the official name of TRS in the protocol is CSI-RS for tracking).

(1) The TRS is implemented as a set of periodic CSI-RS resources, which are configured with a parameter TRS-Info.

(2) In addition, there are some other configuration requirements.

A periodic CSI-RS resource is currently configured with corresponding Quasi Co-Located (QCL) information, which specifically points to a TCI-State. In a CSI-RS resource set, currently, QCL information of different CSI-RS resources may be configured randomly. It will result in a loss of performance, for example, different receiving beams are used to receive the different CSI-RS resources, then corresponding channels for transmitting these different CSI-RS resources will have different statistical characteristics, thus the precision of the timing and frequency tracking/synchronization will be affected.

### SUMMARY

Embodiments of the disclosure relate to the field of wireless communications, and more particularly to a method and apparatus for information determination and configuration, and a computer storage medium.

There is provided a method for information determination, including: receiving, by a terminal device, first configuration information from a network device, the first configuration information being used for configuring a set of Channel State Information-Reference Signal (CSI-RS) resources, where respective CSI-RS resources of the set are quasi co-located with respect to a first Quasi Co-Location (QCL) parameter, and the first configuration information is used for determining CSI-RS resources that are for tracking.

There is provided an apparatus for information determination, including: a memory storing processor-executable instructions; and a processor arranged to execute the stored processor-executable instructions to perform operations of: receiving first configuration information from a network device, where the first configuration information being used for configuring a set of Channel State Information-Reference Signal (CSI-RS) resources, where respective CSI-RS resources of the set are quasi co-located with respect to a first Quasi Co-Location (QCL) parameter, and the first configuration information is used for determining CSI-RS resources that are for tracking.

There is provided an apparatus for information configuration, including: a memory storing processor-executable instructions; and a processor arranged to execute the stored processor-executable instructions to perform operations of: transmitting first configuration information to a terminal device, the first configuration information being used for configuring a set of Channel State Information-Reference Signal (CSI-RS) resources, where respective CSI-RS resources of the set are quasi co-located with respect to a first Quasi Co-Location (QCL) parameter, and the first configuration information is used for determining CSI-RS resources that are for tracking.

### BRIEF DESCRIPTION OF THE DRAWINGS

Drawings described herein are used to provide a further understanding of the disclosure and form a part of the disclosure. The schematic embodiments of the disclosure and their descriptions are used to explain the disclosure and not as any inappropriate limitation on the disclosure. The drawings are shown as following.

FIG. 1 is a schematic flowchart of a method for information determination according to an embodiment of the disclosure.

FIG. 2 is a schematic flowchart of a method for information configuration according to an embodiment of the disclosure.

FIG. 3 is a schematic diagram of the structural composition of an apparatus for information determination according to an embodiment of the disclosure.

FIG. 4 is a schematic diagram of the structural composition of an apparatus for information configuration according to an embodiment of the disclosure.

FIG. 5 is a schematic diagram of the structural composition of a computer device according to an embodiment of the disclosure.

### DETAILED DESCRIPTION

In order to facilitate understanding of the technical solutions of the embodiments of the disclosure, the related technologies involved in the embodiments of the disclosure will be described in the following.

(1) TCI-state

One TCI state may be configured with one or two RS information; each RS information corresponds to a different type of QCL parameter. For instance, two pieces of RS information form a set of QCL information, where RS1 corresponds to QCL-TypeA, and RS2 corresponds to QCL-TypeD. Two pieces of RS information may indicate a same RS or different RSs.

(1) QCL Type

The QCL supported in the current protocol is assumed to correspond to parameters as follows (it can be one item, or a combination of several items):

‘QCL-TypeA’: {Doppler shift, Doppler spread, average delay, delay spread};

‘QCL-TypeB’: {Doppler shift, Doppler spread};

‘QCL-TypeC’: {average delay, Doppler shift};

‘QCL-TypeD’: {Spatial Rx parameter}.

Herein, ‘QCL-TypeD’: {Spatial Rx parameter} is a spatial QCL parameter.

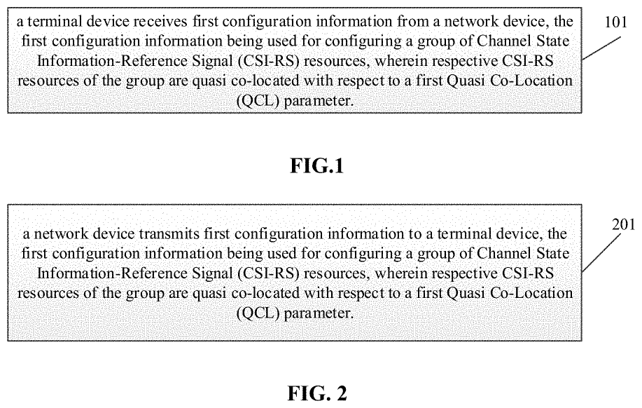

FIG. 1 is a schematic flowchart of a method for information determination according to an embodiment of the disclosure. As shown in FIG. 1, the method for information determination includes operation 101.

In operation 101, a terminal device receives first configuration information from a network device, the first configuration information being used for configuring a set of Channel State Information-Reference Signal (CSI-RS) resources, where respective CSI-RS resources of the set are quasi co-located with respect to a first Quasi Co-Location (QCL) parameter.

According to embodiments of the disclosure, a network configures a set of CSI-RS resources, which can be periodic or non-periodic.

According to an embodiment, the first configuration information is further used for configuring a first indication parameter corresponding to the set of CSI-RS resources, the first indication parameter being configured to indicate a usage of the set of CSI-RS resources. In a specific implementation, the first indication parameter is a parameter Tracking Reference Signal-Info (TRS-Info).

According to embodiments of the disclosure, the first QCL parameter is a spatial QCL parameter, i.e., ‘QCL-TypeD’: {Spatial Rx parameter}.

According to embodiments of the disclosure, respective CSI-RS resources of the set are quasi co-located with respect to a first Quasi Co-Location (QCL) parameter. Specifically, the quasi-co-location with respect to a spatial QCL parameter can be achieved in one or more of ways 1 to 3.

In the way 1, first reference signals indicated by QCL information corresponding to respective CSI-RS resources of the set are quasi co-located with respect to the first QCL parameter, the first reference signals being reference signals corresponding to the first QCL parameter.

For example, a CSI-RS resource 1 (RS1) and a CSI-RS resource 2 (RS2) correspond to a signal X and a signal Y respectively, where the signal X and the RS1 are quasi co-located with respect to the spatial QCL parameter, and the signal Y and the RS2 are also quasi co-located with respect to the spatial QCL parameter. Then, if the RS1 and the RS2 are quasi co-located with respect to the spatial QCL parameter, the signal X and the signal Y will, thereby, be quasi co-located with respect to the spatial QCL parameter.

In the way 2, QCL information corresponding to each of the set of CSI-RS resources indicates a same first reference signal, the first reference signal being a reference signal corresponding to the first QCL parameter.

For example, a CSI-RS resource1 (RS1) and a CSI-RS resource2 (RS2) correspond to a signal X and a signal Y respectively, where the signal X and the RS1 are quasi co-located with respect to the spatial QCL parameter, and the signal Y and the RS2 are also quasi co-located with respect to the spatial QCL parameter. Then, the signal X and the signal Y are quasi co-located with respect to the spatial QCL parameter.

In the way 3, QCL information corresponding to each of the set of CSI-RS resources corresponds to a same Transmission Configuration Indicator State (TCI-State).

Herein, a same TCI-State is used for configuring the QCL information corresponding to each of the set of CSI-RS resources, thus respective CSI-RS resources of the set are quasi co-located with respect to the spatial QCL parameter.

According to embodiments of the disclosure, the terminal device determines a first signal based on the first configuration information, and utilizes the first signal to perform timing and/or frequency tracking/synchronization.

According to embodiments of the disclosure, a terminal device receives first configuration information from a network device, where the first configuration information being used for configuring a set of Channel State Information-Reference Signal (CSI-RS) resources, where respective CSI-RS resources of the set are quasi co-located with respect to a first Quasi Co-Location (QCL) parameter; the terminal device determines a first signal based on the first configuration information, and utilizes the first signal to perform timing and/or frequency tracking/synchronization. With the technical solutions of the embodiments of the disclosure, the timing/frequency tracking (sometimes also termed as synchronization) performance can be improved, thereby the system's performance can also be improved.

FIG. 2 is a schematic flowchart of a method for information configuration according to an embodiment of the disclosure. As shown in FIG. 2, the method for information configuration includes operation 201.

In operation 201, a network device transmits first configuration information to a terminal device, the first configuration information being used for configuring a set of Channel State Information-Reference Signal (CSI-RS) resources, where respective CSI-RS resources of the set are quasi co-located with respect to a first Quasi Co-Location (QCL) parameter.

According to embodiments of the disclosure, a network configures a set of CSI-RS resources, which can be periodic or non-periodic.

According to an embodiment, the first configuration information is further used for configuring a first indication parameter corresponding to the set of CSI-RS resources, the first indication parameter being configured to indicate a usage of the set of CSI-RS resources. In a specific implementation, the first indication parameter is a parameter Tracking Reference Signal-Info (TRS-Info).

According to embodiments of the disclosure, the first QCL parameter is a spatial QCL parameter, i.e., ‘QCL-TypeD’: {Spatial Rx parameter}.

According to embodiments of the disclosure, respective CSI-RS resources of the set are quasi co-located with respect to a first Quasi Co-Location (QCL) parameter. Specifically, the quasi-co-location with respect to a spatial QCL parameter can be achieved in one or more of ways 1 to 3.

In the way 1, first reference signals indicated by QCL information corresponding to respective CSI-RS resources of the set are quasi co-located with respect to the first QCL parameter, the first reference signals being reference signals corresponding to the first QCL parameter.

For example, a CSI-RS resource 1 (RS1) and a CSI-RS resource 2 (RS2) correspond to a signal X and a signal Y respectively, where the signal X and the RS1 are quasi co-located with respect to the spatial QCL parameter and the signal Y and the RS2 are also quasi co-located with respect to the spatial QCL parameter. Then, if the RS1 and the RS2 are quasi co-located with respect to the spatial QCL parameter, the signal X and the signal Y will, thereby, be quasi co-located with respect to the spatial QCL parameter.

In the way 2, QCL information corresponding to each of the set of CSI-RS resources indicates a same first reference signal, the first reference signal being a reference signal corresponding to the first QCL parameter.

For example, a CSI-RS resource 1 (RS1) and a CSI-RS resource 2 (RS2) correspond to a signal X and a signal Y respectively, where the signal X and the RS1 are quasi co-located with respect to the spatial QCL parameter and the signal Y and the RS2 are also quasi co-located with respect to the spatial QCL parameter. Then, the signal X and the signal Y are quasi co-located with respect to the spatial QCL parameter.

In the way 3, QCL information corresponding to each of the set of CSI-RS resources corresponds to a same Transmission Configuration Indicator State (TCI-State).

Herein, a same TCI-State is used for configuring the QCL information corresponding to each of the set of CSI-RS resources, thus respective CSI-RS resources of the set are quasi co-located with respect to the spatial QCL parameter.

Herein, the terminal device determines a first signal based on the first configuration information, and utilizes the first signal to perform timing and/or frequency tracking/synchronization.

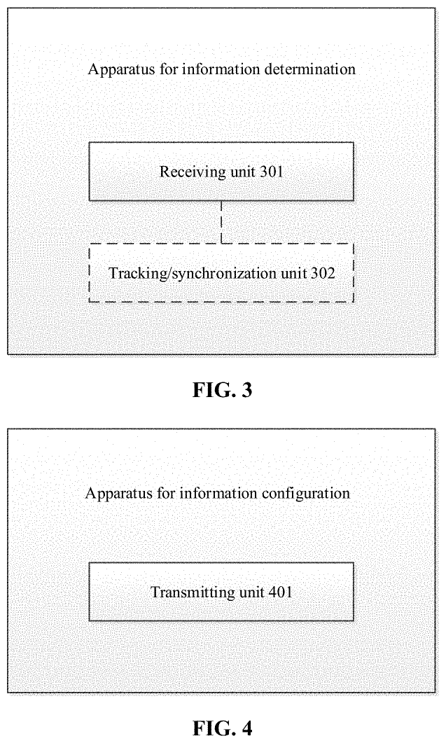

FIG. 3 is a schematic diagram of the structural composition of an apparatus for information determination according to an embodiment of the disclosure. As shown in FIG. 3, the apparatus for information determination includes a receiving unit 301.

The receiving unit 301 is configured to receive first configuration information from a network device, where the first configuration information being used for configuring a set of Channel State Information-Reference Signal (CSI-RS) resources, where respective CSI-RS resources of the set are quasi co-located with respect to a first Quasi Co-Location (QCL) parameter.

According to an embodiment, the apparatus further includes a tracking/synchronization unit 302, which is configured to: determine a first signal based on the first configuration information, and utilize the first signal to perform timing and/or frequency tracking/synchronization.

According to an embodiment, the first QCL parameter is a spatial QCL parameter.

According to an embodiment, the first configuration information is further used for configuring a first indication parameter corresponding to the set of CSI-RS resources, the first indication parameter being configured to indicate a usage of the set of CSI-RS resources.

According to an embodiment, the first indication parameter is a parameter Tracking Reference Signal-Info (TRS-Info).

According to an embodiment, first reference signals indicated by QCL information corresponding to respective CSI-RS resources of the set are quasi co-located with respect to the first QCL parameter, the first reference signals being reference signals corresponding to the first QCL parameter; and/or,

QCL information corresponding to each of the set of CSI-RS resources indicates a same first reference signal, the first reference signal being a reference signal corresponding to the first QCL parameter; and/or,

QCL information corresponding to each of the set of CSI-RS resources corresponds to a same Transmission Configuration Indicator State (TCI-State).

Those skilled in the art should appreciate that the function implemented by each unit in the apparatus for information determination shown in FIG. 3 can be understood by referring to the related description of the foregoing method for information determination. Moreover, the function of each unit in the apparatus for information determination shown in FIG. 3 can be implemented by programs running on a processor, or by a specific logic circuit.

FIG. 4 is a schematic diagram of the structural composition of an apparatus for information configuration according to an embodiment of the disclosure. As shown in FIG. 4, the apparatus for information configuration includes a transmitting unit 401.

The transmitting unit 401 is configured to transmit first configuration information to a terminal device, the first configuration information being used for configuring a set of Channel State Information-Reference Signal (CSI-RS) resources, where respective CSI-RS resources of the set are quasi co-located with respect to a first Quasi Co-Location (QCL) parameter.

According to an embodiment, the first QCL parameter is a spatial QCL parameter.

According to an embodiment, the first configuration information is further used for configuring a first indication parameter corresponding to the set of CSI-RS resources, the first indication parameter being configured to indicate a usage of the set of CSI-RS resources.

According to an embodiment, the first indication parameter is a parameter Tracking Reference Signal-Info (TRS-Info).

According to an embodiment, first reference signals indicated by QCL information corresponding to respective CSI-RS resources of the set are quasi co-located with respect to the first QCL parameter, the first reference signals being reference signals corresponding to the first QCL parameter; and/or,

QCL information corresponding to each of the set of CSI-RS resources indicates a same first reference signal, the first reference signal being a reference signal corresponding to the first QCL parameter; and/or,

QCL information corresponding to each of the set of CSI-RS resources corresponds to a same Transmission Configuration Indicator State (TCI-State).

Those skilled in the art should appreciate that the function implemented by each unit in the apparatus for information configuration shown in FIG. 4 can be understood by referring to the related description of the foregoing method for information configuration. Moreover, the function of each unit in the apparatus for information configuration shown in FIG. 4 can be implemented by programs running on a processor, or by a specific logic circuit.

If the above-mentioned apparatus for information determination or information configuration device in the embodiments of the disclosure is implemented in the form of a software function module, and sold or used as an independent product, it may also be stored in a computer-readable storage medium. Based on this kind of understanding, the technical solutions of the embodiments of the disclosure can be embodied in the form of software products in essence or in the part contributing to the prior art. The computer software product is stored in a storage medium, and includes several instructions to enable a computer device (which may be a personal computer, server, or network device, etc.) to perform all or part of the methods described in the embodiments of the disclosure. The aforementioned storage medium includes various media that can store program codes, such as a U disk, a mobile hard disk, a Read-Only Memory (ROM), a magnetic disk, or an optical disk. As such, the embodiments of the disclosure will not be limited to any specific combination of hardware and software.

Accordingly, the embodiments of the disclosure further provide a computer storage medium, which has stored thereon computer executable instructions that, when executed by a processor, cause operations of the aforementioned method for information determination and configuration to be performed.

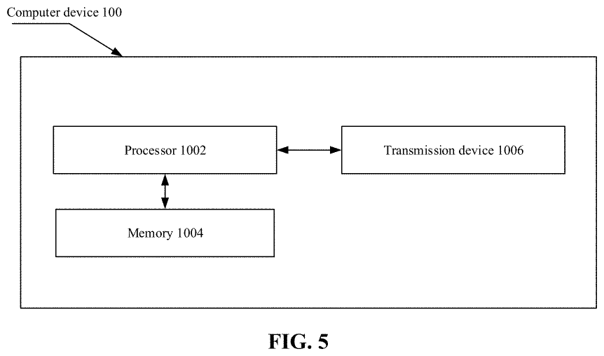

FIG. 5 is a schematic diagram of the structural composition of a computer device according to an embodiment of the disclosure, where the computer device may be a terminal device, or a network device. As shown in FIG. 5, a computer device 100 may include one or more processor 1002 (only one shown in the figure), the processor may include but not limited to a processing device such as a Micro Controller Unit (MCU) or a Field Programmable Gate Array (FPGA). In addition, the computer device 100 may further include a memory 1004 for storing data, and a transmission device 1006 for communication function. Those of ordinary skill in the art should understand that the structure shown in FIG. 5 is only schematic, which does not limit the structure of the above electronic device. For instance, a computer device 100 can also include more or fewer components than that shown in FIG. 5, or have a different configuration from that shown in FIG. 5.

The memory 1004 may be used to store software programs and modules of the application software, such as program instructions/modules corresponding to the methods in the embodiments of the disclosure, and the processor 1002 runs the software programs and modules stored in the memory 1004, such that various functional applications and data processing can be performed, i.e., the above methods are implemented. The memory 1004 may include a high-speed random access memory, and may also include a non-volatile memory, such as one or more magnetic storage devices, flash memory, or other non-volatile solid-state memory. In some embodiments, the memory 1004 may further include memories remotely provided with respect to the processor 1002, and these remote memories may be connected with the computer device 100 through a network. Examples of the above network include but are not limited to the Internet, intranet, local area network, mobile communication network, and combinations thereof.

The transmission device 1006 is used to receive or transmit data via a network. One specific embodiment of the above network may include a wireless network provided by the communications providers of the computer device 100. In an embodiment, the transmission device 1006 may include a Network Interface Controller (NIC), which can be connected with other network devices through a base station, thus to communicate with the Internet. In an embodiment, the transmission device 1006 may be a Radio Frequency (RF) module, which is used for connecting wirelessly with the Internet for communication.

The technical solutions described in the embodiments of the disclosure can be arbitrarily combined in the case of no conflicts.

In several embodiments provided by the disclosure, it should be understood that the disclosed methods and intelligent devices can also be implemented in other ways. And the embodiments for the devices described above are only schematic, for example, the division of the units is only a logical function division, and there can be other division methods in actual implementation. For example, multiple units or components can be combined, or can be integrated into another system, or some features can be ignored or not implemented. Moreover, the coupling, or direct coupling, or communication connection between the components shown or discussed above may be through some interfaces, indirect coupling or communication connection of devices or units, which may be electrical, mechanical or other forms.

The units described above as separated component may be, or may not be physically separated. A component shown as a unit may be, or may not be a physical unit, that is, it may be located in one place or distributed to multiple network units; some or all of the units may be selected according to actual needs to achieve the purpose of the embodiments of the disclosure.

In addition, the functional units in the embodiments of the disclosure may all be integrated into one second processing unit, or each unit may be separately used as a unit, or two or more units may be integrated into one unit; the above integrated unit can be implemented in the form of hardware, or in the form of hardware plus software functional units.

The above are only the specific embodiments of the disclosure, but the protection scope of the disclosure is not limited to this. Any person skilled in the art can easily think of changes or replacements within the technical scope disclosed by the disclosure, which shall be covered in the protection scope of the disclosure.

1. A method for information determination, comprising:
receiving, by a terminal device, first configuration information from a network device, the first configuration information being used for configuring a set of Channel State Information-Reference Signal (CSI-RS) resources, wherein respective CSI-RS resources of the set are quasi co-located with respect to a first Quasi Co-Location (QCL) parameter, and the first configuration information is used for determining CSI-RS resources that are for tracking.

2. The method of claim 1, wherein the first QCL parameter is QCL-TypeD.

3. The method of claim 1, wherein the first configuration information is further used for configuring a first indication parameter corresponding to the set of CSI-RS resources, the first indication parameter being configured to indicate a usage of the set of CSI-RS resources.

4. The method of claim 3, wherein the first indication parameter is a parameter Tracking Reference Signal-Info (TRS-Info).

5. The method of claim 1,
wherein first reference signals indicated by QCL information corresponding to respective CSI-RS resources of the set are quasi co-located with respect to the first QCL parameter, the first reference signals being reference signals corresponding to the first QCL parameter; and/or,
QCL information corresponding to each of the set of CSI-RS resources indicates a same first reference signal, the first reference signal being a reference signal corresponding to the first QCL parameter; and/or,
QCL information corresponding to each of the set of CSI-RS resources corresponds to a same Transmission Configuration Indicator State (TCI-State).

6. The method of claim 5, wherein the QCL information is comprised in the TCI-State.

7. An apparatus for information determination, comprising:
a memory storing processor-executable instructions; and
a processor arranged to execute the stored processor-executable instructions to perform operations of:
receiving first configuration information from a network device, the first configuration information being used for configuring a set of Channel State Information-Reference Signal (CSI-RS) resources, wherein respective CSI-RS resources of the set are quasi co-located with respect to a first Quasi Co-Location (QCL) parameter, and the first configuration information is used for determining CSI-RS resources that are for tracking.

8. The apparatus of claim 7, wherein the first QCL parameter is QCL-TypeD.

9. The apparatus of claim 7, wherein the first configuration information is further used for configuring a first indication parameter corresponding to the set of CSI-RS resources, the first indication parameter being configured to indicate a usage of the set of CSI-RS resources.

10. The apparatus of claim 9, wherein the first indication parameter is a parameter Tracking Reference Signal-Info (TRS-Info).

11. The apparatus of claim 7,
wherein first reference signals indicated by QCL information corresponding to respective CSI-RS resources of the set are quasi co-located with respect to the first QCL parameter, the first reference signals being reference signals corresponding to the first QCL parameter; and/or,
QCL information corresponding to each of the set of CSI-RS resources indicates a same first reference signal, the first reference signal being a reference signal corresponding to the first QCL parameter; and/or,
QCL information corresponding to each of the set of CSI-RS resources corresponds to a same Transmission Configuration Indicator State (TCI-State).

12. The apparatus of claim 11, wherein the QCL information is comprised in the TCI-State.

13. An apparatus for information configuration, comprising:
a memory storing processor-executable instructions; and
a processor arranged to execute the stored processor-executable instructions to perform operations of:
transmitting first configuration information to a terminal device, the first configuration information being used for configuring a set of Channel State Information-Reference Signal (CSI-RS) resources, wherein respective CSI-RS resources of the set are quasi co-located with respect to a first Quasi Co-Location (QCL) parameter, and the first configuration information is used for determining CSI-RS resources that are for tracking.

14. The apparatus of claim 13, wherein the first QCL parameter is QCL-TypeD.

15. The apparatus of claim 13, wherein the first configuration information is further used for configuring a first indication parameter corresponding to the set of CSI-RS resources, the first indication parameter being configured to indicate a usage of the set of CSI-RS resources.

16. The apparatus of claim 15, wherein the first indication parameter is a parameter Tracking Reference Signal-Info (TRS-Info).

17. The apparatus of claim 13,
wherein first reference signals indicated by QCL information corresponding to respective CSI-RS resources of the set are quasi co-located with respect to the first QCL parameter, the first reference signals being reference signals corresponding to the first QCL parameter; and/or,
QCL information corresponding to each of the set of CSI-RS resources indicates a same first reference signal, the first reference signal being a reference signal corresponding to the first QCL parameter; and/or,
QCL information corresponding to each of the set of CSI-RS resources corresponds to a same Transmission Configuration Indicator State (TCI-State).

18. The apparatus of claim 17, wherein the QCL information is comprised in the TCI-State.
